(19) United States
(12) Patent Application Publication
(10) Pub. No.: US 2017/0321328 A1
(43) Pub. Date: Nov. 9, 2017

(54) PLASTIC VAPOR DEGREASER AND CLEANING METHODS

(71) Applicant: Honeywell International Inc., Morris Plains, NJ (US)

(72) Inventors: Joshua A. Crayne, East Amherst, NY (US); Jon T. Herdlein, Buffalo, NY (US); Anthony M. Anzalone, Angola, NY (US); Ryan J. Hulse, Getzville, NY (US)

(21) Appl. No.: 15/586,833

(22) Filed: May 4, 2017

Related U.S. Application Data
(60) Provisional application No. 62/333,532, filed on May 9, 2016.

(51) Int. Cl. C23G 3/00; B08B 5/00; B08B 7/00; C23G 5/028

(52) U.S. Cl. CPC C23G 3/00; C23G 5/02841; B08B 5/00; B08B 7/00

(57) ABSTRACT

The present disclosure provides a degreasing apparatus which may be made at least partially, or substantially, of at least one plastic material, for use with solvents having relatively low boiling points that are chemically compatible with plastic materials, such as 1233zd (1-chloro-3,3,3-trifluoro-propene, CF₃CH═CHCl). Plastic degreasing apparatuses may comprise a tank comprising a side wall and a bottom wall, a partition coupled to a lower portion of the tank, dividing the tank into an immersion sump and a vaporizing sump, a heating element located within the vaporizing sump, and a condensing element positioned above the lower portion, wherein at least one of the side wall, the bottom wall, and the partition is made of a plastic material.

### CROSS-REFERENCE TO RELATED APPLICATIONS

This application claims priority to U.S. Provisional Patent Application Ser. No. 62/333,532, filed on May 9, 2016 and entitled PLASTIC VAPOR DEGREASER AND CLEANING METHODS, the entire disclosure of which is hereby expressly incorporated by reference.

### FIELD

This disclosure relates generally to plastic vapor degreasers and methods of cleaning using vapor degreasing.

### BACKGROUND

Vapor degreasing is an important operation in many major industries such as aerospace, micro-mechanics, optics, electronics and others where a high reliability and low failure rate is required. In these industries, significant initial capital investment is often required for vapor degreasing and, thus, may be a significant barrier to entry and/or to changing an existing cleaning process. Moreover, current trends in modern manufacturing to move to production cells, where all tools necessary for a job are within arm's reach to improve efficiency, may be frustrated by the capital investment requirements currently needed in conventional vapor degreasing.

With these production cells, it is important to be able to have the cleaning process portable and/or small enough to fit near the worksite. The solvent will also need to have the right safety properties such a low toxicity and non-flammability so that it can be safely used in the production area and ideally, would also have a low global warming potential.

Materials for current degreasers are limited to those which can withstand the high operating temperatures of aggressive solvents. Many conventional degreasers therefore are constructed of metals, such as stainless steel, which makes them expensive due to material price, labor hours, and necessary tools/processes for their manufacture. The weight of these machines when built from metals also reduces their portability and increases their transport cost.

A low cost, portable and durable degreaser capable of being used with low boiling point solvents is needed.

### SUMMARY

The present disclosure provides a degreasing apparatus which may be made at least partially, or substantially, of at least one plastic material, for use with solvents having relatively low boiling points that are chemically compatible with certain plastic materials, such as 1233zd (1-chloro-3,3,3-trifluoro-propene, CF₃CH═CHCl).

As used herein, the term “substantially” when used in conjunction with a degreasing apparatus made of a plastic material, includes degreasing apparatuses where any or all solvent-wetted parts that are non-heat transfer parts are made at least partially, or entirely, of at least one plastic material. As used herein, “non-heat transfer parts” include any part not specifically dedicated to a heat transfer purpose, including, for example, sumps, pipes for solvent transport, sidewalls, bottom walls, and partitions as disclosed herein.

In various embodiments, the degreasing apparatus itself, including its tank(s), structures within its tank(s) and any immediately surrounding or integrated components such as fittings, but not including external supporting structures or external, attached components such as pumps or filters, may comprise at least 25% plastic by weight, at least 50% plastic by weight, or at least 75% plastic by weight, such as 25% to 100% plastic, 50% to 100% plastic, 75% to 100% plastic, 50% to 95% plastic, 70% to 95% plastic, and 75% to 95% plastic. The various plastic components of the degreasing apparatus may be made of the same type of plastic, or may be made of different plastics.

As used herein, the term “relatively low boiling point” or “low boiling point” include solvents or mixtures of solvents with boiling points below 40° C., below 35° C., below 25° C., and below 20° C., such as boiling points within the ranges of 15° C. to 25° C., 15° C. to 35° C., 15° C. to 40° C., 17° C. to 40° C., 17° C. to 25° C., and 17° C. to 20° C.

Also, as used herein, the term “chemically compatible”, or plastics that are chemically “compatible” with solvents, include plastics that experience at least one of: less than a 5% change in weight and less than a 5% change in volume after being immersed in the solvent for a period of two weeks at room temperature (between 20° C. to 23° C.). In further embodiments, a chemically compatible plastic may experience at least one of: less than a 3%, 1%, 0.5%, or 0.2% change in weight and less than a 3%, 1%, 0.5%, or 0.2% change in volume after being immersed in the solvent for a period of two weeks at room temperature (between 20° C. to 23° C.). Furthermore, chemically compatible plastics may also exhibit no substantial no color change by visual inspection after being immersed in the solvent for two weeks.

Advantageously, the use of low boiling point and plastic compatible solvents, such as 1233zd (1-chloro-3,3,3-trifluoro-propene, CF₃CH═CHCl) and more preferably trans-1233zd (trans-1-chloro-3,3,3-trifluoro-propene, CF₃CH═CHCl), in turn allows for the use of plastic materials for the degreaser, as opposed to the use of more expensive metal or metal alloy materials which are otherwise necessary for high boiling point, plastic incompatible solvents of the type currently used in degreasing applications. Additionally, 1233zd is also environmentally preferable, having a low Global Warming Potential (GWP) of 1, has low toxicity, and is non-flammable according the ASTM E-681.

In various embodiments, degreasing apparatuses may include a tank having a side wall and a bottom wall, a partition coupled to a lower portion of the tank, dividing the tank into an immersion sump and a vaporizing sump, a vaporizing element associated with the vaporizing sump, and a condensing element positioned above the lower portion, wherein at least one of the side wall, the bottom wall, and the partition is made of a plastic material according to various embodiments.

The present disclosure also provides methods of degreasing an article that may include the steps of providing a degreasing apparatus formed at least in part from a plastic material and containing a degreasing solvent, vaporizing the degreasing solvent to provide a vapor space, disposing an article in the vapor space, and condensing the vapor in a vapor recovery space according to various embodiments.

### BRIEF DESCRIPTION OF THE DRAWINGS

The above mentioned and other features of the invention, and the manner of attaining them, will become more apparent and the invention itself will be better understood by reference to the following description of embodiments of the invention taken in conjunction with the accompanying drawings.

FIG. 1 illustrates an exemplary schematic for a degreasing system;

FIGS. 2A-C illustrate an exemplary vapor degreasing system according to various embodiments;

FIG. 3A illustrates the flow pattern of solvent according to various embodiments; and

FIG. 3B illustrates the flow diagram of a method of degreasing an article with a plastic degreaser illustrated in FIG. 3A.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

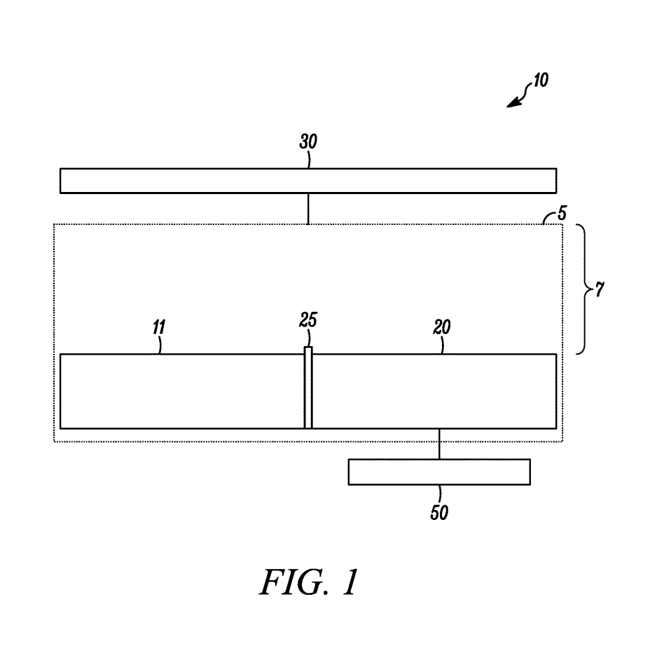

Referring first to FIG. 1, an exemplary degreasing apparatus 10 of the present disclosure is illustrated. Degreasing apparatus 10 may comprise a polymeric or plastic tank 5. Plastic tank 5 may be divided into an immersion sump 11 and a vaporizing sump 20. Plastic tank 5, immersion sump 11, and vaporizing sump 20 are not particularly limited and, may include any means for separating the solvent being vaporized and the solvent being recovered by solvent condenser 30 from vapor zone 7.

For example, in FIG. 1, partition 25 may be used to separate immersion sump 11 and vaporizing sump 20. In some embodiments, the immersion sump 11 and the vaporizing sump 20 may be separate plastic wells capable of holding the solvent.

The solvent can be vaporized using any known methods for vaporizing a solvent including means for altering the temperature of the solvent and/or the pressure of the system. For example, the solvent may be heated by an electrical heating element, gas heater, solar heater, or via a fluid heat transfer system, such as heating element 50.

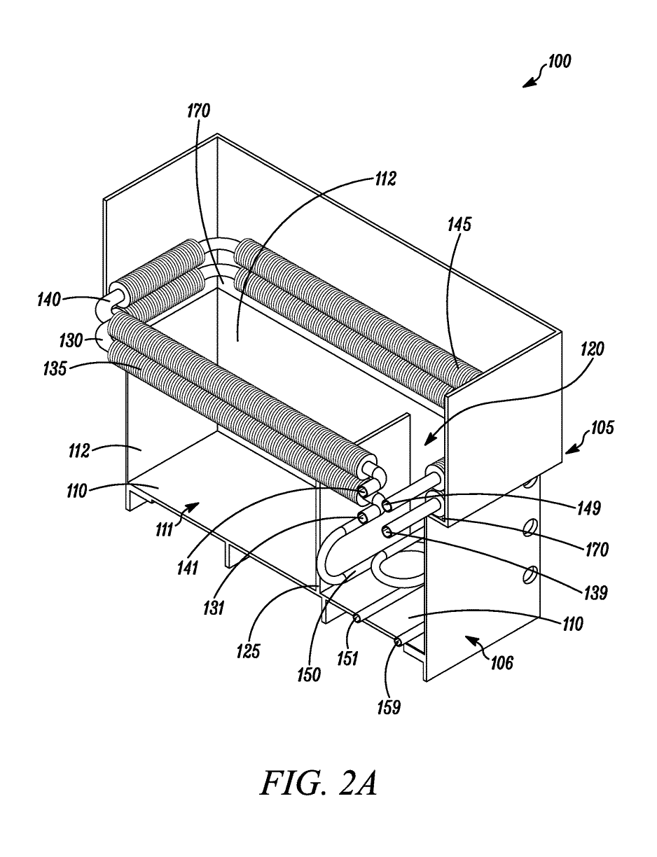

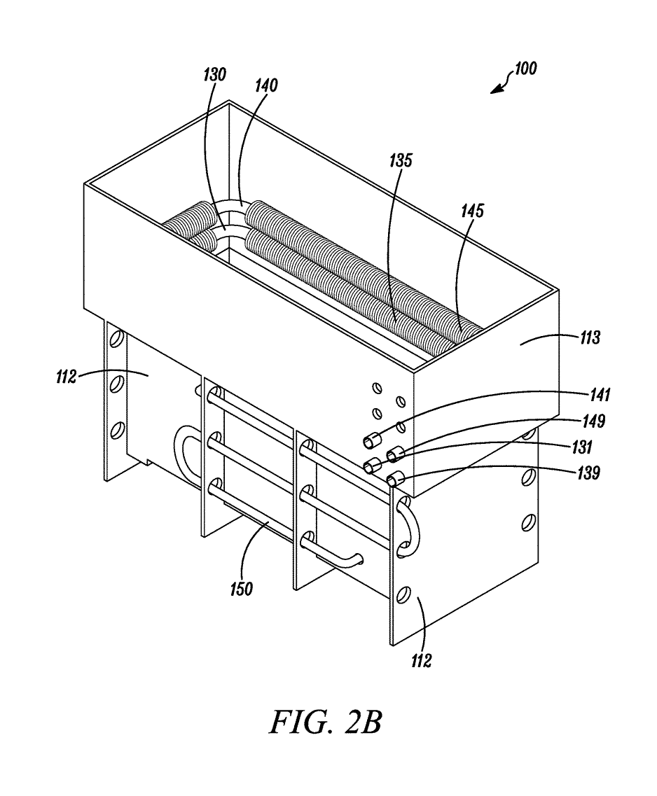

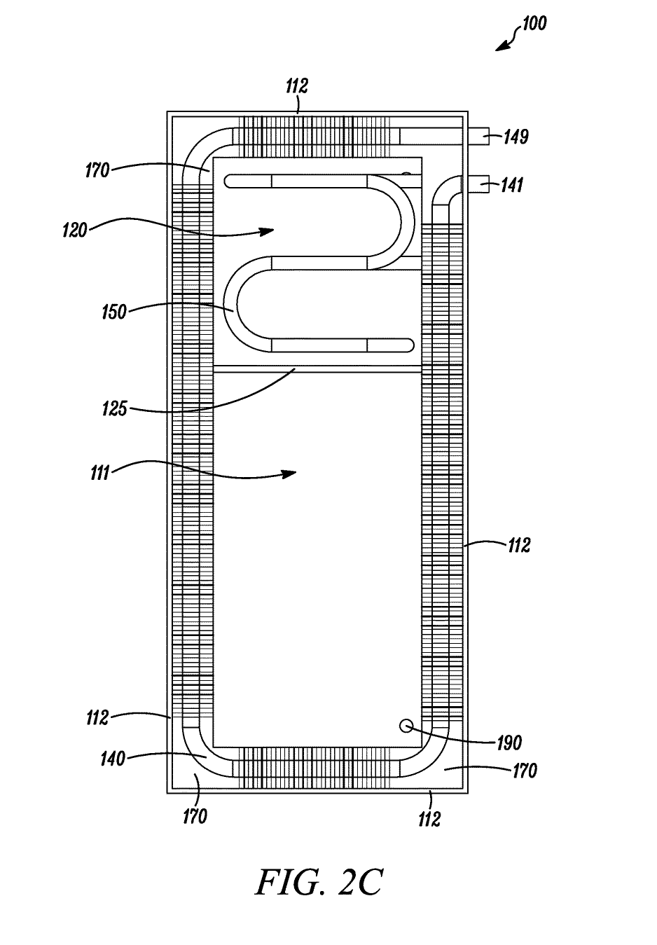

The solvent can also be recovered through any known method of recovering vapor, such as condensing with solvent condenser 30. Condensing may be accomplished through changes in pressure and/or temperature, such as cooling the vapors. For example, FIGS. 2A-2C illustrate two condensing elements, including first cooling coil 135 and second cooling coil 145, which are positioned vertically adjacent one another to form a condensing barrier, forcing vapors exiting from vaporizing sump 120 to condense into a trough 170 immediately below condensing elements 130 and 140 and below coils 135 and 145 surrounding the liquid and vapor regions. From here, condensed solvent returns to immersion sump 11.

In some embodiments, the cooling coils may be maintained at temperatures below the boiling point of the solvent. Exemplary cooling coil temperatures include temperatures less than 10° C., temperatures less than 5° C., temperatures less than 0° C., temperatures less than −10° C., and temperatures less than −15° C., such as temperatures within the ranges of −25° C. to 10° C., −25° C. to 5° C., −25° C. to −10° C., −25° C. to −15° C., 10° C. to −15° C., 5° C. to −15° C., and 4° C. to −10° C.

With reference to FIGS. 2A-C, an exemplary degreasing apparatus 100 is illustrated. FIG. 2A illustrates a perspective view of degreasing apparatus 100 with one of the side walls 112 removed, while FIG. 2B illustrates a perspective view of degreasing apparatus 100 with all side walls 112. FIG. 2C illustrates an overhead view of degreasing apparatus 100.

As illustrated in FIGS. 2A-2C, the degreasing apparatus may comprise a tank 105 including a side wall 112 and a bottom wall 110. Tank 105 may also include a partition 125 coupled to a lower portion 106 (e.g., bottom wall 110) of the tank 105, dividing the tank 105 into an immersion sump 111 and a vaporizing sump 120.

The geometry of the degreasing apparatus 100 is not particularly limited. Various portions of the degreasing apparatus (e.g., side wall 112, tank 105, partition 125, immersion sump 111, and a vaporizing sump 120) may be shaped into various suitable geometries, as would be recognized by a skilled artisan. For example, the degreasing apparatus may be rectangular as exemplified in FIGS. 2A-2C. In other embodiments, the degreasing apparatus may be substantially round in shape and, thus in various annular embodiments, may include only a single side wall 112.

Degreasing apparatus 100 may also include a vaporizing element associated with the vaporizing sump 120. For example, the vaporizing element may be located within the vaporizing sump 120, such as heating coil 150, which is exemplified in FIGS. 2A and 2C as being located within the vaporizing sump 120. In various embodiments, heating coil 150 may be a pipe capable of transporting a heating fluid through heating coil inlet 151 and heating coil outlet 159. In various embodiments, the heating coil may be at a temperature of more than 20° C., more than 15° C., more than 10° C., or more than 5° C. above the boiling point of the solvent, such as 5° C. to 20° C. above the boiling point of the solvent, 10° C. to 20° C. above the boiling point of the solvent, 15° C. to 20° C. above the boiling point of the solvent, 5° C. to 15° C. above the boiling point of the solvent, 5° C. to 10° C. above the boiling point of the solvent, or 10° C. to 15° C. above the boiling point of the solvent.

FIGS. 2A-2C also illustrate an exemplary first condensing element 130 and an exemplary second condensing element 140. As illustrated in FIGS. 2A and 2B, first condensing element 130 and/or second condensing element 140 may be located above the lower portion 106 of the tank, for example in vapor recovery portion 113. Various embodiments may include condensing elements capable of transporting a cooling liquid. For example, first condensing element 130 and second condensing element 140 includes a first condensing fluid inlet 131 and second condensing inlet 141 and also a first condensing fluid outlet 139 and second condensing fluid outlet 149 respectively. In various embodiments, heating coil 150, first condensing element 130, and/or second condensing element 140 may comprise thermally conductive materials, such as a metal or metallic alloy.

In various embodiments, by constructing the heating coil 150, first condensing element 130, and/or second condensing element 140 with thermally conductive materials, such as a metal, heat transfer can be improved. The thermally conductive material is not particularly limited and may be any known thermally conducive material. Exemplary metals include at least one of iron, copper, aluminum, nickel, chromium, titanium, molybdenum, tungsten, ruthenium, silver, gold, cadmium, zinc, alloys thereof, or combinations thereof. Thus, in some embodiments the metal may be a nickel-chromium based alloy, such as INCONEL 78. In other embodiments, the metal may comprise iron, such as steel pipes (e.g., stainless steel).

Advantageously, with the use of a low boiling point solvent such as trans-1233zd, compositions of which are disclosed in U.S. Pat. No. 8,772,213 entitled SOLVENT COMPOSITIONS INCLUDING TRANS-1-CHLORO-3,3,3-TRIFLUOROPROPENE AND USES THEREOF which is incorporated herein by reference in its entirety, tank 105 may be constructed partially or entirely of at least one plastic material. By constructing all or part of tank 105 with at least one plastic, the degreasing apparatus may be more insulated for reducing ambient heat loss through the degreaser. In various embodiments, at least one of the side walls 112, bottom 110, or partition 125 may comprise a plastic.

In various embodiments, the plastic may include a thermoplastic and/or a thermoset plastic. The type of plastic is not particularly limited, provided that the plastic is not adversely affected by the solvent being used.

Exemplary thermoplastics include at least one of acrylonitrile butadiene styrene (“ABS”), nylon, polycarbonate (“PC”), polyethermide (“PEI”), polyethylene (“PE”) (e.g., high-density polyethylene (“HDPE”)), polyvinyl chloride (“PVC”), polytetrafluoroethylene (“PTFE”), polyvinylidene fluoride (“PVDF”), polyoxymethylene (“POM”), polyethylene terephthalate (“PET”), or mixtures thereof. In various embodiments, the polyvinyl chloride may be a chlorinated polyvinyl chloride (“CPVC”).

In the prior art, plastics have conventionally been considered to be incompatible with conventional degreasers due to the incomparability of plastic with the solvents of conventional degreasers. However, certain new solvents, such as trans-1233zd, commercially available under the SOLSTICE® brand from HONEYWELL INTERNATIONAL INC., a Delaware corporation, advantageously facilitate the use of plastic degreasers.

Trans-1233zd (trans-1-chloro-3,3,3-trifluoro-propene, CF₃CH═CHCl) is a new solvent that has recently been introduced to the cleaning market. Trans-1233zd is compatible with various polymers such as polyoxymethylene (e.g., DELRIN®, a registered trademark of E. I. DuPont Nemours and Company, a Delaware corporation), HDPE, polycarbonate, polyethermide (e.g., ULTEM®, a registered trademark of SABIC Global Technologies, a corporation of the Netherlands), polyvinylidene fluoride (e.g., KYNAR®, a registered trademark of Atofina Chemicals, Incorporated, a Pennsylvania corporation), polytetrafluoroethylene (e.g., TEFLON®, a registered trademark of E. I. DuPont Nemours and Company, a Delaware corporation), polypropylene, PVC and PET. By utilizing a plastic that is compatible with trans-1233zd the weight, cost to manufacture and cost to operate can be reduced significantly. A degreaser was fabricated from PVC for the examples below. PVC is available from many industrial suppliers and other commercial sources.

Typical plastics such as polyoxymethylene, HDPE, polycarbonate, polyethermide, polyvinylidene fluoride, polytetrafluoroethylene, polypropylene, PVC and PET are ideally suited for use with the preferred solvents of the present invention, including particularly those preferred solvents having a boiling point below 40° C., such as trans-1233zd (trans-1-chloro-3,3,3-trifluoro-propene, CF₃CH═CHCl). For example the boiling point of trans-1233zd (trans-1-chloro-3,3,3-trifluoro-propene, CF₃CH═CHCl) is 19° C., which is well below the temperature at which the mechanical strength of PVC begins to deteriorate, e.g., by dissolving or swelling (around 45° C.). Aside from chemical incompatibility, other, higher boiling solvents could not be used with PVC as they boil at temperatures that would structurally degrade the material when at normal atmospheric pressures.

Operating heaters below 35° C. for vaporizing the fluid may be desirable to maintain adequate mechanical strength of the degreaser. Processes such as fluid distillation may be accomplished with heaters that run at temperatures and pressures within the acceptable range of many plastics, such as PVC. As a result of the heating values when using 1233zd (1-chloro-3,3,3-trifluoro-propene, CF₃CH═CHCl), distillation may be accomplished at atmospheric pressures and temperatures within the acceptable range of plastics, while still maintaining a sufficient turnover rate of clean fluid.

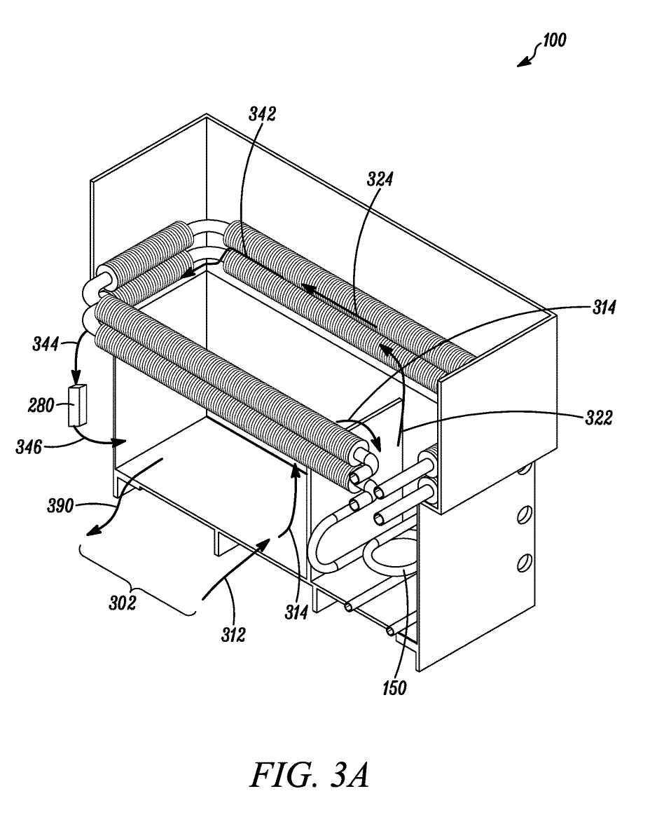

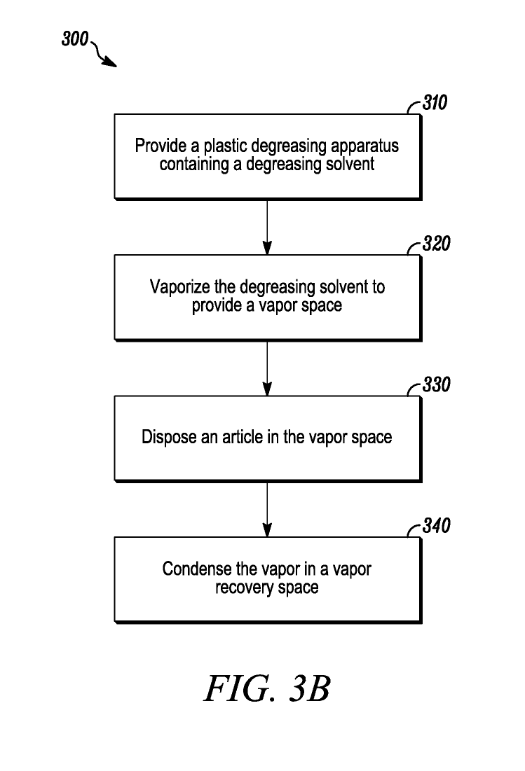

FIG. 3A illustrates an exemplary flow path 302 of the degreaser apparatus, and FIG. 3B illustrates the steps of an exemplary method 300 for degreasing an article. With reference to FIG. 3B, method 300 may include providing a plastic degreasing apparatus containing a degreasing solvent (step 310), vaporizing the degreasing solvent to provide a vapor space (step 320), placing or disposing an article in the vapor space (step 330), and condensing the vapor in a vapor recovery space (step 340).

Providing a plastic degreasing apparatus containing a degreasing solvent (step 310) is not particularly limited, and may include providing solvent from an inlet stream 312 (shown in FIG. 3A) from a solvent source, such as a solvent pump (not shown).

The solvent in the immersion sump 111 may rise over partition 125 and flow into the vapor sump (120 shown in FIGS. 2A and 2C), where the solvent then may be vaporized to provide a vapor space (step 320). For example, the solvent may be vaporized by heating the solvent with heat coil 150. The solvent vapor stream 322 may then rise over the partition (shown as 125 in FIGS. 2A and 2C) to provide vapor space 324, where an article for degreasing may be disposed (step 330).

The vapor in contact with coils 135 and 145 may then condense 342 in a vapor recovery space (step 340). Condensed solvent returns to immersion sump 111 (flow path 346) from a collecting tube/water separator box 280 (shown in FIG. 3A) that is in fluid communication with the trough 170 beneath coils 135 and 145 (illustrated as flow path 344). By providing the solvent in vapor form from the vapor sump (120 in FIGS. 2A and 2C), the purity of the solvent (e.g., trans-1-chloro-3,3,3-trifluoro-propene) in the vapor space and in the immersion sump 111 may be improved and/or maintained. The condensed solvent may additionally flow out (shown as outflow 390 in FIG. 3A) though outlet 190 (shown in FIG. 2C), where it may be collected, filtered and or pumped (not shown) back into inlet stream 312, completing flow path 302.

In view of the fact that the boiling point of trans-1-chloro-3,3,3-trifluoro-propene (1233zd) is near room temperature, containing and processing it within a material that helps shield it from the environment is beneficial. Plastics, such as PVC also have insulating properties that prevent heat loss from the solvent used, reducing heat flux from the external environment through the walls of the apparatus or pipes. Therefore, a further advantage of using plastic materials for the tank is the reduction of undesired solvent evaporation as well as facilitating minimized energy/heat input for increased efficiency.

An additional cost benefit of manufacturing a degreaser from a plastic material such as PVC is the ease with which the components of the degreaser can be fabricated relatively quickly and easily with shop tools, such as shop tools that are common to basic wood working. For example, table saws and miter saws may be used to cut the plastic material effectively, leaving surfaces that have a smooth finish, which facilitates downstream, secondary assembly of the individual plastic degreaser components. Chemical welding of the plastic parts with standard PVC cement is facilitated by cleanly finished cuts, and significantly reduces required labor hours as opposed to heated plastic welding. Other manufacturing operations similar to those used in metal working, such as threading holes for various fittings, can still be performed in the same manner with plastic components with a regular drill and tap set. In this manner, the use of plastic for the components of the degreaser disclosed herein facilitates manufacture without the need of specialized tools.

### EXAMPLES

### Example 1

### Compatibility of Carious Solvents with PVC

Chemical compatibility of the solvent with the materials of construction is an important consideration in the design of a vapor degreaser, and the combined effects of chemical, thermal, and mechanical loading on a material will inform a proper construction of a degreaser. To this effect, a series of soak tests of PVC samples were performed using solvents including in VERTREL® SDG (a registered trademark of E. I. DuPont Nemours and Company, a Delaware corporation), n-Propyl Bromide, and trans-1233zd. Pieces of PVC were solvent welded together and allowed to soak in the boiling solvent for approximately 1 day. Table 1 below summarizes the results of the compatibility test, which illustrates the compatibility of trans-1233zd with PVC.

TABLE 1
Compatibility of PVC With Various Solvents

| Solvent | Effect on PVC | Pass/Failed |
|---|---|---|
| nPB | Immediately attacked PVC and completely | Failed |
| | destroyed PVC by the end of the test. | |
| VERTREL ® | Softened PVC and caused welded joint | Failed |
| SDG | to warp and then break. | |
| Trans-1233zd | No effect of PVC or welded joints. | Pass |

As can be seen in Table1, PVC was not compatible with 1-Bromopropane (“nPB”) or VETREL® SDG, a trans-1,2-dichloroethylene (t-DCE) and hydrofluorocarbon mixture commercially available from Dupont®. However, trans-1-chloro-3,3,3-trifluoro-propene (trans-1233zd) was found to not adversely affect the PVC.

### Example 2

### Degreaser Construction

A degreaser, shown in FIGS. 1A-C, was constructed from PVC for trials with trans-1233zd. The entire degreaser with the exception of the cooling coils and heating loop was constructed from PVC, which was solvent welded together. The cooling coils and heating coils were operated using an external circulating baths. The degreaser was configured to hold approximately 5 gal of solvent.

### Example 3

### Degreaser Performance—Loss Rates and Turnover

The degreaser in as exemplified in FIGS. 2A-C was charged with 5 gallons of trans-1-chloro-3,3,3-trifluoro-propene (trans-1233zd). The coiling coils were operated at 4° C. and the heating coils were maintained at 22.5° C. With the degreaser operating under these conditions loss rates were ˜0.15 lbs/hr with a turnover rate in the rinse sump of 5.1 lbs/hr. The loss rates of a typical vapor degreaser are ˜0.1 lbs/hr and this simple setup achieved nearly the industry standard without the use of sub-zero coils which means that chilled water supply could be used making it easier to set up at customer sites. Also, smooth cooling coils were used rather than finned types. If finned coils were used, the effective heat transfer area would be noticeably increased, allowing for improved containment of the solvent.

The temperature of the cooling coils was then lowered to −10° C. and the temperature of the heating coils maintained at ˜24° C. to study the effect of loss rate versus coil temperature. The loss rate was reduced to 0.09 lbs/hr with a turnover rate of 8.9 lbs/hr. Lowering the coil temperature to −10° C. yielded a 75% greater turnover with only 50% the losses while using smooth cooling coils. Without being limited to any theory, it is believed that finned coils may allow for an even lower loss rate due to the increased surface area for heat transfer. After running trans-1233zd for 1 month in the PVC degreaser there was no sign of visual attack or degradation of the PVC. The PVC degreaser did not form any leaks or show any sign of deterioration.

### Example 4

### Compatibility of Trans-1233zd with Common Plastics

Commonly used plastics were immersed in trans-1233zd for 2 weeks. The weights and volumes of the plastics were measured before and after the 2 week immersion. Many of the plastics saw a weight and volume change of less than 5% which was determined to be acceptable. Both HIPS and acrylics were greatly affected by trans-1233zd in this application and were determined to be unacceptable for use as a construction material for a plastic degreaser when using trans-1233zd as the solvent.

TABLE 2
Compatibility of Trans-1233zd With Various Plastics

| | % Wt | |
|---|---|---|
| Plastic | Change | % Vol Change |
| NYLON 66 | −0.09% | −0.09% |
| POLYETHERIMIDE (ULTEM ®) | 0.035% | −0.52% |
| PET | 0.08% | 0.015% |
| PVC (PVC-TYPE 1) | 0.10% | 0.04% |
| PVDF (KYNAR ®) | 0.13% | −0.27% |
| POLYOXYMETHYLENE | 0.54% | 0.61% |
| (DELRIN ®) | | |
| HDPE | 1.70% | 1.19% |
| POLYTETRAFLUOROETHYLENE | 2.13% | 3.93% |
| (TEFLON ®) | | |
| ABS | 3.35% | 3.55% |
| POLYCARBONATE | 3.55% | 2.98% |
| POLYPROPYLENE | 4.96% | 3.68% |
| HIPS | 23.29% | 83.10% |

| | |
|---|---|
| ACRYLIC | Substrate totally dissolved |
| | in 24 hours |

As can be seen in Table 2, trans-132zd was compatible with numerous polymers, including polyamide (Nylon 66), polyethermide (ULTEM®, a registered trademark of SABIC Global Technologies, a corporation of the Netherlands), PET, PVC, PVDF, POM (DELRIN®, a registered trademark of E. I. DuPont Nemours and Company, a Delaware corporation), HDPE, PTFE (TEFLON®, a registered trademark of E. I. DuPont Nemours and Company, a Delaware corporation), ABS, polycarbonate, and polypropylene. However, HIPS and acrylics were seen as having a significant weight and volume change (greater than 5%).

Thus, a plastic degreasing apparatus may be used as a vapor degreaser when combined with an appropriate solvent, such as trans-1233zd (1-chloro-3,3,3-trifluoro-propene, CF₃CH═CHCl). Accordingly, plastic degreasing apparatuses when used with the aforementioned appropriate solvents provide compatible, low-cost, reasonably durable degreasers that are more portable and that are capable of widespread use in production cells.

While this invention has been described as relative to exemplary designs, the present invention may be further modified within the spirit and scope of this disclosure. Further, this application is intended to cover such departures from the present disclosure as come within known or customary practice in the art to which this invention pertains.

What is claimed is:

1. A degreasing apparatus comprising:
a tank comprising a side wall and a bottom wall;
a partition coupled to a lower portion of the tank, dividing the tank into an immersion sump and a vaporizing sump;
a vaporizing element associated with the vaporizing sump; and
a condensing element positioned above the lower portion of the tank;
wherein at least one of the side wall, the bottom wall, and the partition is made of a plastic material.

2. The degreasing apparatus of claim 1, further comprising a solvent disposed within the tank, the solvent having a boiling point less than 40° C.

3. The degreasing apparatus of claim 2, wherein the solvent has a boiling point between 15° C. to 35° C.

4. The degreasing apparatus of claim 3, wherein the solvent is trans-1-chloro-3,3,3-trifluoro-propene.

5. The degreasing apparatus of claim 1, wherein the plastic is a thermoplastic.

6. The degreasing apparatus of claim 5, wherein the thermoplastic is selected from the group consisting of acrylonitrile butadiene styrene (“ABS”), nylon, polycarbonate (“PC”), polyethermide (“PEI”), polyethylene (“PE”), polyvinyl chloride (“PVC”), polytetrafluoroethylene (“PTFE”), polyvinylidene fluoride (“PVDF”), polyoxymethylene (“POM”), polyethylene terephthalate (“PET”), and mixtures thereof.

7. The degreasing apparatus of claim 6, wherein the thermoplastic is polyvinyl chloride (“PVC”).

8. The degreasing apparatus of claim 7, wherein the polyvinyl chloride (“PVC”) is a chlorinated polyvinyl chloride (“CPVC”).

9. The degreasing apparatus of claim 1, wherein the plastic is a plastic that exhibits at least one of: less than a 5% change in weight and less than a 5% change in volume after being immersed in the solvent for a period of two weeks at room temperature.

10. The degreasing apparatus of claim 9, wherein the plastic is selected from the group consisting of acrylonitrile butadiene styrene (“ABS”), nylon, polycarbonate (“PC”), polyethermide (“PEI”), polyethylene (“PE”), polyvinyl chloride (“PVC”), polytetrafluoroethylene (“PTFE”), polyvinylidene fluoride (“PVDF”), polyoxymethylene (“POM”), polyethylene terephthalate (“PET”), and mixtures thereof.

11. The degreasing apparatus of claim 10, wherein the plastic is a plastic that exhibits at least one of: less than a 1% change in weight and less than a 1% change volume after being immersed in the solvent for a period of two weeks at room temperature.

12. The degreasing apparatus of claim 11, wherein the plastic is a plastic that exhibits at least one of: less than a 0.2% change in weight and less than a 0.2% change in volume after being immersed in the solvent for a period of two weeks at room temperature.

13. The degreasing apparatus of claim 12, wherein the plastic is selected from the group consisting of nylon, polyethermide (“PEI”), polyvinyl chloride (“PVC”), polyvinylidene fluoride (“PVDF”), polyethylene terephthalate (“PET”), and mixtures thereof.

14. The degreasing apparatus of claim 1, wherein the degreasing apparatus comprises at least 50% plastic by weight.

15. A method of degreasing an article comprising:
providing a plastic degreasing apparatus containing a degreasing solvent;
vaporizing the degreasing solvent to provide a vapor space;
disposing an article in the vapor space; and
condensing the vapor in a vapor recovery space.

16. The method of claim 15, wherein said degreasing solvent has a boiling point between 15° C. to 35° C.

17. The method of claim 16, wherein the solvent is trans-1-chloro-3,3,3-trifluoro-propene.

18. The method of claim 15, wherein the plastic degreasing apparatus comprises a thermoplastic.

19. The method of claim 18, thermoplastic is selected from the group consisting of acrylonitrile butadiene styrene (“ABS”), nylon, polycarbonate (“PC”), polyethermide (“PEI”), polyethylene (“PE”), polyvinyl chloride (“PVC”), polytetrafluoroethylene (“PTFE”), polyvinylidene fluoride (“PVDF”), polyoxymethylene (“POM”), polyethylene terephthalate (“PET”), and mixtures thereof.

20. The method of claim 15, wherein the degreasing apparatus comprises at least 50% plastic by weight.
